(19) United States
(12) Patent Application Publication
(10) Pub. No.: US 2025/0373037 A1
(43) Pub. Date: Dec. 4, 2025

(54) ROTATABLE INDUCTIVE CHARGING TRAY FOR VEHICLE

(71) Applicant: Ford Global Technologies, LLC, Dearborn, MI (US)

(72) Inventors: Martin J. Drumb, Chesterfield Twp, MI (US); Lauren Michelle Marzolf, Newport, MI (US); Matthew Jameson Hickey, Canton, MI (US); Frank Qiukui Liu, Canton, MI (US)

(73) Assignee: Ford Global Technologies, LLC, Dearborn, MI (US)

(21) Appl. No.: 18/675,366

(22) Filed: May 28, 2024

(51) Int. Cl. H02J 7/00; B60R 11/00; B60R 11/02; B60R 16/02; H02J 50/00; H02J 50/10

(52) U.S. Cl. CPC H02J 7/0044; B60R 11/00; B60R 11/02; H02J 50/005; H02J 50/10; B60R 2011/0007; B60R 2011/008; B60R 16/0207

(57) ABSTRACT

An inductive charging tray assembly for a vehicle has a base plate configured to be mounted onto a structure on the vehicle, a hinge, and a tray pivotally coupled to the base plate by way of the hinge. The hinge allows the tray to rotate between a vertical position and a horizontal position. The tray has a charging region configured to hold an inductive charger and a device region located proximate to the charging region and configured to hold a rechargeable device such that the inductive charger inductively couples with the rechargeable device.

### FIELD OF THE DISCLOSURE

The present disclosure generally relates to inductive charging arrangement in a vehicle, and more particularly relates to a deployable tray having inductive charging for charging mobile electronic devices onboard a vehicle.

### BACKGROUND OF THE DISCLOSURE

Motor vehicles are commonly equipped with various charging ports for charging mobile electronic devices such as phones, for example, that have one or more batteries that are electrically chargeable. More recently, vehicles have become equipped with wireless charging that employs inductive charging, such as a fixed inductive charging tray which has induction charging circuitry that inductively couples with inductive charging circuitry in the mobile electronic device being charged. It may be desirable to provide for a versatile charging device holding tray that includes inductive charging for use on a vehicle.

### SUMMARY OF THE DISCLOSURE

According to a first aspect of the present disclosure, an inductive charging tray assembly for a vehicle has a base plate configured to be mounted onto a structure on the vehicle, a hinge, and a tray pivotally coupled to the base plate by way of the hinge. The hinge allows the tray to rotate between a vertical position and a horizontal position. The tray has a charging region configured to hold an inductive charger and a device region located proximate to the charging region and configured to hold a rechargeable device such that the inductive charger inductively couples with the rechargeable device.

Embodiments of the first aspect of the present disclosure can include any one or a combination of the following features:
the tray is configured to rotate approximately 90 degrees between the vertical and horizontal positions;
the hinge comprises a friction hinge;
the hinge comprises two friction hinges aligned on a pivot axis;
the tray is configured to receive an inductive charging device installed by a user, and wherein the inductive charging device may be removed from the charging region by the user;
a cover insert removably disposed between the device region and the charger region;
a power cable for supplying electrical power to the inductive charger;
a power cable retention feature for holding the power cable associated with the inductive charger;
a device retention clip for retaining the rechargeable device; and
the base plate is configured to be mounted on a vertical structure on the vehicle.

According to a second aspect of the present disclosure, an inductive charging tray assembly for a vehicle has a base plate configured to be mounted onto a vertical structure on the vehicle, one or more friction hinges defining a pivot axis, and a tray pivotally coupled to the base plate by way of the one or more friction hinges. The one or more friction hinges allow the tray to rotate about the pivot axis between a vertical position and a horizontal position. The tray comprises a charging region configured to hold an inductive charger and a device region located proximate to the charging region and configured to hold a rechargeable device such that the inductive charger inductively couples with the rechargeable device.

Embodiments of the second aspect of the present disclosure can include any one or a combination of the following features:
the tray rotates approximately 90 degrees between the vertical and horizontal positions;
the hinge comprises two friction hinges aligned on the pivot axis;
the tray is configured to receive an inductive charging device installed by a user, and wherein the inductive charging device may be removed from the charging region;
a cover insert removably disposed between the device region and the charger region;
a power cable output for supplying electrical power to the inductive charger;
a cable retention feature for holding the power cable associated with the inductive charger;
a device retention clip for retaining the chargeable device; and
the base plate is configured to be mounted on a vertical structure on the vehicle.

According to a third aspect of the present disclosure, a motor vehicle has a passenger compartment, a supporting structure in the passenger compartment, and an inductive charging tray assembly. The inductive charging tray assembly has a base plate configured to be mounted onto a vertical structure on the vehicle, one or more friction hinges defining a pivot axis, and a tray pivotally coupled to the base plate by way of the one or more friction hinges. The one or more friction hinges allow the tray to rotate about the pivot axis between a vertical position and a horizontal position. The tray comprises a charging region configured to hold an inductive charger and a device region located proximate to the charging region and configured to hold a rechargeable device such that the inductive charger inductively couples with the rechargeable device.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a passenger compartment of a motor vehicle equipped with a rotatable inductive charging tray assembly shown with a tray in a stowed vertical position;

FIG. 2 is a cross-sectional taken through line II-II of FIG. 1 with the inductive charging tray assembly shown with the tray in the stowed vertical position;

FIG. 3 is an upper perspective view of the inductive charging tray assembly with the tray shown rotated about hinges to a deployed horizontal position;

FIG. 4 is a cross-sectional view taken through line II-II of FIG. 4 with the inductive charging tray assembly with the tray shown in the deployed horizontal position;

FIG. 5 is an upper perspective view of the inductive charging tray assembly with the insert and chargeable electronic devices removed;

FIG. 6 is a lower perspective view of the inductive charging tray assembly shown in the deployed horizontal position; and

FIG. 7 is a block diagram illustrating the inductive coupling and charging of a chargeable mobile device.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

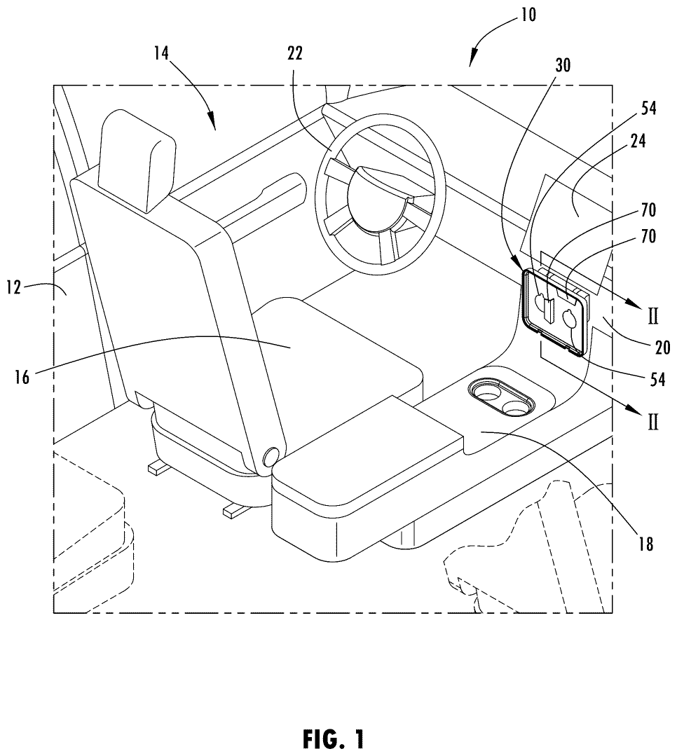

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a rotatable inductive charging tray assembly for a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, a passenger compartment 14 of a motor vehicle 10 is generally illustrated equipped with a rotatable inductive charging tray assembly 30, according to one embodiment. The vehicle 10 may be a motor vehicle, for example, a wheeled motor vehicle which may include a car, a truck, a van, a bus, an SUV, etc. The passenger compartment 14 is generally defined by a body 12 which may include body panels, doors, windows, a floor and a roof. The passenger compartment 14 is generally equipped with a seating arrangement having one or more seats such as a driver's seat 16 for seating a driver of the motor vehicle 10 and other seats for seating one or more passengers. It should be appreciated that the motor vehicle 10 may include any of a number of seats 16, including a front row of seating and one or more rear rows of seating. It should further be appreciated that one or more rotatable inductive charging tray assemblies 30 may be employed on the motor vehicle 10, generally in one or more locations that are readily accessible to one or more occupants seated in the motor vehicle 10.

The passenger compartment 14 is further illustrated having a steering wheel 22 generally located forward of the driver's seat 16 and a dashboard 20 that extends along a front portion of the passenger compartment 14 forward of the steering wheel between lateral sides of the motor vehicle 10. A center console 18 is shown located adjacent to the driver's seat 16 which generally separates the driver's seat 16 from a right side passenger seat in the front row of seating. The center console 18 generally extends vehicle forward to a location approaching or abutting the rearward side of the dashboard 18 shown in one example.

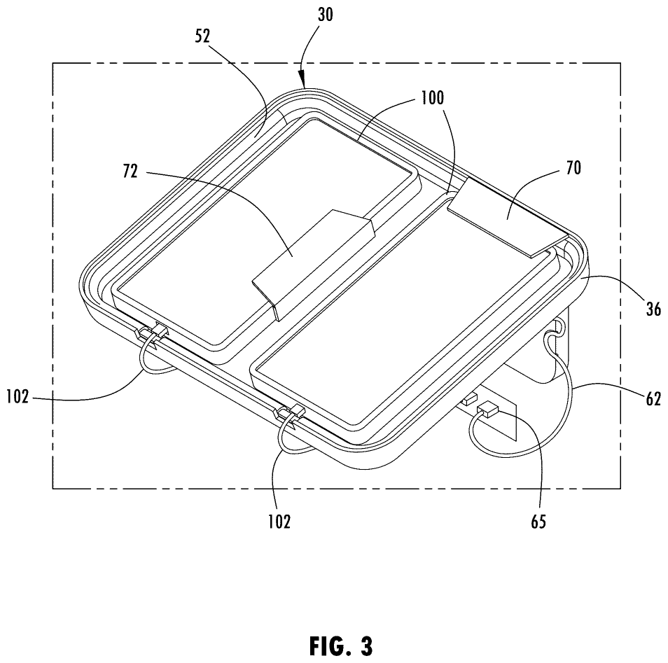

In the example shown, the rotatable inductive charging tray assembly 30 is shown located on and supported by a vehicle rearward vertical portion of the dashboard 18, generally above the forward end of the center console 18. The rotatable inductive charging tray assembly 30 is shown in FIG. 1 with a tray 36 in a stowed vertical first position in which a tray thereof is rotated and thereby tilted to a deployed vertical first position such that the tray 36 is stowed in a more compact position that generally parallels the rear vertical portion of the dashboard 20. The rotatable inductive charging tray assembly 30 is rotatable to a second position as is generally shown in FIG. 3 by rotating the tray 36 upward and forward by approximately 90 degrees. In the second position, the tray 30 of the inductive charging tray assembly 30 is generally oriented substantially horizontal. As such, the rotatable inductive charging tray assembly 30 is configured with the tray 36 to be tilted and rotated at an angle θ in a range between about 0-90 degrees between the vertical first and horizontal second positions.

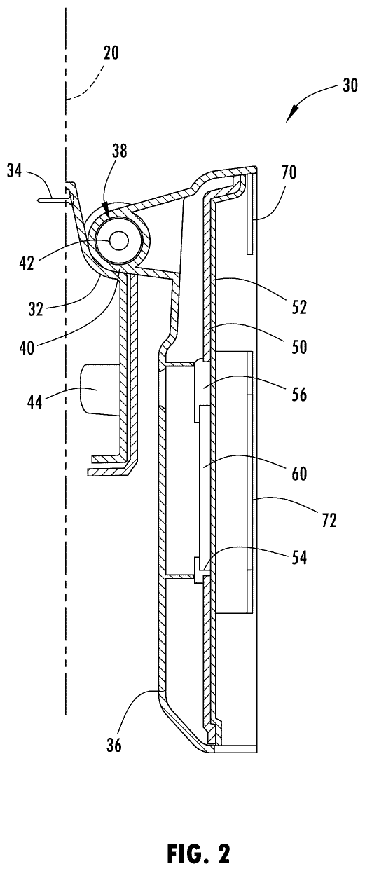

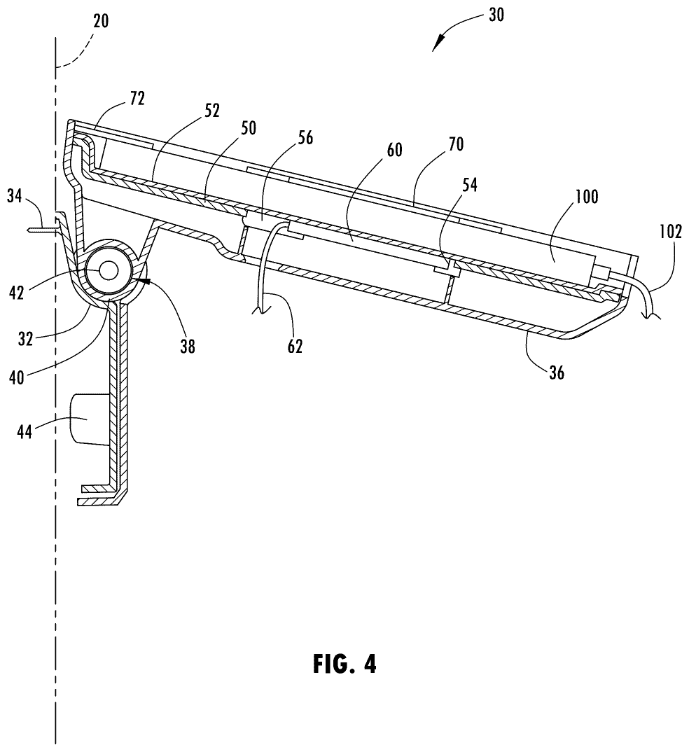

Referring to FIGS. 2 and 4, the rotatable inductive charging tray assembly 30 is illustrated with the tray 36 in both the first vertical and second horizontal positions, respectively. The rotatable inductive charging tray assembly 30 includes a mounting baseplate 32 which is shown generally extending parallel to and vertically along an outer surface of the rear vertical portion of the dashboard 20. The baseplate 32 is fastened to the dashboard 20 via a plurality of fasteners 34, such as threaded screws or bolts, for example. The baseplate 32 generally extends vertical and downward from the fasteners 34 along a vertical portion of the dashboard 20 in the example shown. The baseplate 32 includes a bumper 44 near a lower forward end proximate to and facing the dashboard 20 which may provide a contact surface that may contact the dashboard 20 and prevent further forward movement of the baseplate 32. The bumper 44 may include an elastomeric material that acts as a dampener to reduce forces applied by the bumper 44 onto the dashboard 20.

The rotatable inductive charging tray assembly 30 includes the tray 36 that is pivotally connected to the baseplate 32 via a pair of friction hinges 38 which extend horizontally along a transverse axis of the motor vehicle 10 and define a pivot axis. The tray 36 has a collar 40 on each friction hinge which surrounds and frictionally engages a central pin 42 that extends through the baseplate 32 to define the friction hinges 38. The friction between the collar 40 and pin 42 is sufficient to maintain the tray 36 in either the vertical first position or horizontal second position to withstand forces experienced during normal driving conditions of the motor vehicle 10. To move the tray 36 to rotate between the first and second positions, a user may forcefully engage the tray 36 and apply force sufficient to overcome the friction of the friction hinges 38 and rotate the tray 36 downward to the vertical first position or upward to the horizontal second position.

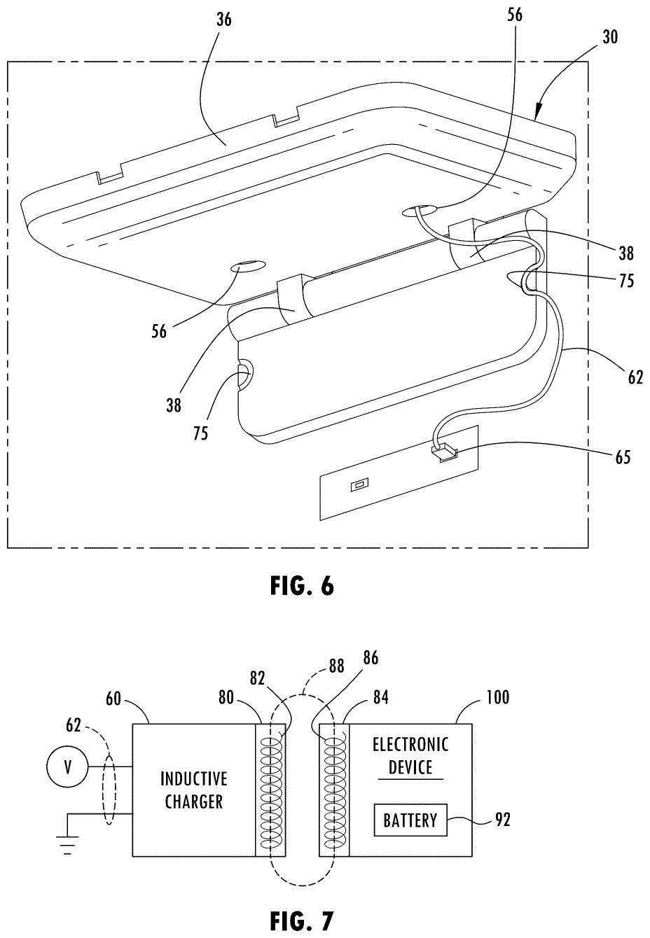

The tray 36 generally defines a shallow compartment with raised side walls that is configured to receive one or more chargeable mobile electronic devices 100 that are equipped with inductive charging circuitry. The tray 36 in the example shown is configured to receive two chargeable mobile electronic devices 100 such as two mobile phones, for example, having one or more chargeable batteries. However, it should be appreciated that any of a number of mobile rechargeable electronic devices 100 may be stowed and charged on the rotatable inductive charging tray assembly 30. The tray 36 generally defines a region 52 in the form of a recess configured to receive a wireless charging device, such as an inductive charging device 60 which, in one example, is disc shaped. A user may insert an inductive charging device 60 into the recess 54 and may connect a charging cable 62 which extends downward through an opening 56 to an electrical power supply via a power port 65 provided on the motor vehicle 10 as seen in FIG. 6. The upper surface of the tray 36 and recess 54 may be covered with a thin insert 52. As such, a user may insert a portable inductive charging device 60 into each recess 54 and dispose the insert 52 on top thereof such that the inductive charging device 60 is hidden from view. It should be appreciated that the insert 52 is preferably thin, such as less than a few millimeters, to allow the chargeable mobile electronic device 100 to be sufficiently close to the puck for optimal inductive coupling and charging.

The portable charging device 60 includes inductive charging circuitry and a magnet extending around a perimeter thereof that is configured and used to align and magnetically attach to a chargeable mobile electronic device having inductive charging circuitry. In the example shown, the insert 52 is disposed between the mobile chargeable electronic device 100 and the inductive charging device 60. However, it should be appreciated that the tray 36 may be utilized without the insert 52, according to other embodiments.

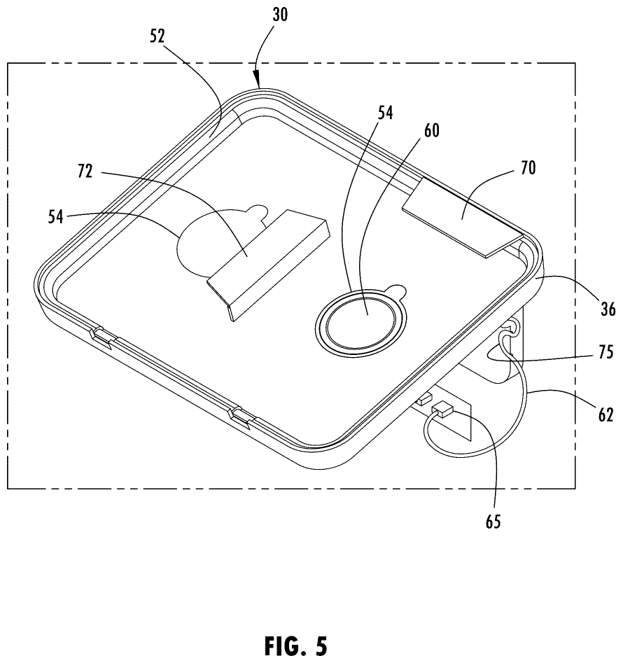

As seen in FIG. 5, the inductive charging device 60 is shown inserted within the recess 54. The insert 52 is further illustrated having a first retainer 70 and a second retainer 72. The first and second retainers 70 and 72 may be flexible retainers in the form of clips configured to bend upward and apply a return force downward to retain one more mobile electronic devices 100. As illustrated in FIG. 3, the first retainer 70 may retain a top end of a mobile electronic device, whereas the second retainer 72 may retain a side portion of a mobile electronic device 100. It should be appreciated that one or more retainers may be provided on the top, bottom or sides of the chargeable mobile electronic devices 100 that are to be held on the tray 36.

Referring to FIG. 7, the inductive charging device 60 is shown having inductive charging circuitry 80 which may include inductive coils 82. The mobile chargeable electronic device 100 is also shown having inductive charging circuitry 84 which may likewise include inductive coils 86. When the mobile electronic device 100 is positioned sufficiently close to the inductive charger device 60 (e.g., within 10 cm), the inductive charging circuitry 80 in the inductive charger 60 may be inductive coupled to the inductive charging circuitry 84 in the mobile electronic device 100 to enable the inductive charger device 60 to charge one or more batteries 92 in the mobile electronic device 100. Typically, this may be achieved by coupling the inductive coils 82 of the inductive charger device 60 with the inductive coils 86 of the mobile electronic device 100 to create an inductive field 88. The inductive charger device 60 receives power from a voltage supply V and is coupled to ground through the power cable 62. The power cable 62 may be electrically coupled to the vehicle battery and ground via circuitry such as the plug-in connector 65, for example, a USB connector.

Accordingly, the rotatable inductive charging tray assembly 30 advantageously provides for tilt adjustable tray and wireless inductive charging station on a motor vehicle 10.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. An inductive charging tray assembly for a vehicle, the inductive charging tray assembly comprising:
a base plate configured to be mounted onto a structure on the vehicle;
a hinge; and
a tray pivotally coupled to the base plate by way of the hinge, wherein the hinge allows the tray to rotate between a vertical position and a horizontal position, and wherein the tray comprises a charging region configured to hold an inductive charger and a device region located proximate to the charging region and configured to hold a rechargeable device such that the inductive charger inductively couples with the rechargeable device.

2. The inductive charging tray assembly of claim 1, wherein the tray is configured to rotate approximately 90° between the vertical and horizontal positions.

3. The inductive charging tray assembly of claim 2, wherein the hinge comprises a friction hinge.

4. The inductive charging tray assembly of claim 3, wherein the hinge comprises two friction hinges aligned on a pivot axis.

5. The inductive charging tray assembly of claim 1, wherein the tray is configured to receive an inductive charging device installed by a user, wherein the inductive charging device may be removed from the charging region by the user.

6. The inductive charging tray assembly of claim 5, further comprising a cover insert removably disposed between the device region and the charger region.

7. The inductive charging tray assembly of claim 1, further comprising a power cable for supplying electrical power to the inductive charger.

8. The inductive charging tray assembly of claim 7, further comprising a power cable retention feature for holding the power cable associated with the inductive charger.

9. The inductive charging tray assembly of claim 1, further comprising a device retention clip for retaining the rechargeable device.

10. The inductive charging tray assembly of claim 1, wherein the base plate is configured to be mounted on a vertical structure on the vehicle.

11. An inductive charging tray assembly for a vehicle, the inductive charging tray assembly comprising:
a base plate configured to be mounted onto a vertical structure on the vehicle;
one or more friction hinges defining a pivot axis; and
a tray pivotally coupled to the base plate by way of the one or more friction hinges, wherein the one or more friction hinges allow the tray to rotate about the pivot axis between a vertical position and a horizontal position, and wherein the tray comprises a charging region configured to hold an inductive charger and a device region located proximate to the charging region and configured to hold a rechargeable device such that the inductive charger inductively couples with the rechargeable device.

12. The inductive charging tray assembly of claim 11, wherein the tray rotates approximately 90 degrees between the vertical and horizontal positions.

13. The inductive charging tray assembly of claim 11, wherein the hinge comprises two friction hinges aligned on the pivot axis.

14. The inductive charging tray assembly of claim 11, wherein the tray is configured to receive an inductive charging device installed by a user, and wherein the inductive charging device may be removed from the charging region.

15. The inductive charging tray assembly of claim 14, further comprising a cover insert removably disposed between the device region and the charger region.

16. The inductive charging tray assembly of claim 11, further comprising a power cable output for supplying electrical power to the inductive charger.

17. The inductive charging tray assembly of claim 11, further comprising a cable retention feature for holding the power cable associated with the inductive charger.

18. The inductive charging tray assembly of claim 11, further comprising a device retention clip for retaining the chargeable device.

19. The inductive charging tray assembly of claim 11, wherein the base plate is configured to be mounted on a vertical structure on the vehicle.

20. A motor vehicle comprising:
a passenger compartment;
a supporting structure in the passenger compartment; and
an inductive charging tray assembly comprising:
a base plate configured to be mounted onto a vertical structure on the vehicle;
one or more friction hinges defining a pivot axis; and
a tray pivotally coupled to the base plate by way of the one or more friction hinges, wherein the one or more friction hinges allow the tray to rotate about the pivot axis between a vertical position and a horizontal position, and wherein the tray comprises a charging region configured to hold an inductive charger and a device region located proximate to the charging region and configured to hold a rechargeable device such that the inductive charger inductively couples with the rechargeable device.
